(19) United States
(12) Patent Application Publication
(10) Pub. No.: US 2007/0280140 A1
(43) Pub. Date: Dec. 6, 2007

(54) SELF-OPTIMIZING NETWORK TUNNELING PROTOCOL

(76) Inventors: Thiruvengadam Venketesan, Delhi (IN); Wu-Hon F. Leung, Downers Grove, IL (US)

Correspondence Address: VEDDER PRICE KAUFMAN & KAMMHOLZ, 222 N. LASALLE STREET, CHICAGO, IL, 60601, US

(21) Appl. No.: 11/755,570

(22) Filed: May 30, 2007

Related U.S. Application Data
(60) Provisional application No. 60/803,435, filed on May 30, 2006.

(51) Int. Cl. H04L 12/28; H04L 12/56

(52) U.S. Cl. 370/254; 370/400

(57) ABSTRACT

A network includes a first plurality of routers that do not implement a desired protocol in communication with a second plurality of routers that implement at least the desired protocol and a tunneling protocol. Routers implementing the tunneling protocol are preferably implemented at the boundaries of domains, i.e., in those routers that serve as interfaces between domains. Each router automatically determines whether it is proper to forward a received message in either a format native to the desired protocol or encapsulated using a legacy protocol. The tunneling protocol can be disabled in a given router as deployment of the desired protocol increases. Conversely, if deployment of the desired protocol decreases, the tunneling protocol may be resumed in a given router. Using this progressive deployment feature, the tunneling protocol in accordance with the instant disclosure maximizes use of the desired protocol while minimizing, in an automatic fashion, use of tunnels.

### REFERENCE TO RELATED APPLICATION

The present patent application also claims priority from and the benefit of U.S. Provisional Patent Application No. 60/803,435, filed May 30, 2006, and entitled AUTOMATED TUNNELING WITH PROGRESSIVE DEPLOYMENT FOR MULTI-CAST ROUTING PROTOCOLS, which prior application is hereby incorporated herein by reference.

### FIELD OF THE INVENTION

The present invention relates generally to communication networks and, in particular, to techniques for optimizing use of a tunneling protocol in such networks where a desired protocol is not universally deployed.

### BACKGROUND OF THE INVENTION

As known in the art, communication networks such as the Internet or World Wide Web generally comprise, among other things, routers that, as their name implies, function to route data between various entities (e.g., server computers, client or receiving computers, etc.) coupled to the network. In order to efficiently communicate with each other, the routers may implement any of a number of communication protocols. However, the use of such communication protocols tends to be an all-or-nothing type scenario: if most routers in the network implement a given communication protocol, then the protocol tends to gain wide—even universal—acceptance; otherwise, few, if any, routers will implement the communication protocol. This creates several problems when attempting to deploy new, often more efficient/effective, communication protocols.

For example, Internet Protocol (IP) Multicast service supports one-to-many or many-to-many communications, in which a sender sends only one copy of a message and the network, i.e., the routers, duplicates the message as the message is forwarded in a routing tree to the necessary receivers. In comparison with so-called unicast routing (i.e., from a single sender to a single receiver), in which the sender must send separate messages to each receiver, multicast routing can significantly reduce the amount of network traffic required to send data to a larger number of receivers. Although many routers in the Internet are IP multicast-capable, the capability is mostly disabled, with less than three percent of the Internet having operational IP multicast, in large part because of the inability of the multicast routers to interface directly with legacy unicast routers. Thus, two routers using multicast protocol but separated by unicast routers would be unable to communicate with each other via multicast.

To address such situations, “tunnels” may be employed. As known in the art, such tunnels are achieved by taking messages in a newer, presumably desired protocol format and encapsulating them with appropriate headers in the legacy protocol format. In this manner, the encapsulated message may be passed through the legacy routers and subsequently de-capsulated upon arrival at a router implementing the desired protocol. However, system administrators typically have to provision such tunnels manually. Adding to the overhead, the tunnel configurations may change each time a multicast-aware router is commissioned or decommissioned in the network. Referring once again to the example of IP multicast, one solution that has been proposed, AMT (Automatic Multicast Without Explicit Tunnels), does enable a form of automatic tunneling through the use of specially equipped routers at the borders of domains implementing the desired protocol. However, AMT also suffers from various drawbacks, including reliance on an alternative network (i.e., the so-called Multicast Backbone or MBONE) and, perhaps more significantly, difficulty in decommissioning AMT elements as multicast becomes more widely adopted. These various shortcomings, again in the context of IP multicast, are further illustrated with reference to FIGS. 1A and 1B.

In FIGS. 1A and 1B, a network 100 comprises various domains 102-110. In the various Figures described herein, including FIGS. 1A and 1B, routers implementing a desired protocol (such as, for example, IP multicast) are illustrated as solid-lined circles; routers implementing both the desired protocol and a tunneling protocol (such as AMT, in FIGS. 1A and 1B, or a tunneling protocol in accordance with various embodiments of the present invention) are illustrated using shaded circles. Routers that do not implement the desired protocol (nor, by default, the tunneling protocol) and therefore only implement the legacy protocol are illustrated by the dotted-lined circles. Multicast receivers are illustrated using black ovals, and multicast sources are illustrated by the letter “S”. Communication paths implementing the desired protocol are illustrated with heavy, solid arrows, whereas tunnels are illustrated using heavy, dashed arrows.

FIG. 1A illustrates exemplary initial connectivity between domain C 106 with domains A and B 102, 104 for a multicast group originating in domain C 106. In this example, routers C₁, A₁ and B₁ are deployed AMT gateways for their respective domains (again, at the borders thereof). Initially, domain X 108 is not multicast aware as shown in FIG. 1A, hence two direct tunnels are established as shown: one from C₁ to A₁ and other from C₁ to B₁. Subsequently, when domain X 108 adopts the desired protocol, e.g., IP multicast, a new AMT gateway X₁ is provided, as shown. In light of this, it would be desirable to reconfigure tunnel connectivity as shown in FIG. 1B, i.e., only between X₁ and C₁, because A₁ and B₁ no longer need to be gateways. However, this cannot be achieved automatically with AMT as long as A₁ and B₁ continue to be functional. As a result, the tunneling connectivity will remain as in FIG. 1A unless administrators of domains A, B and X co-ordinate. In short, prior art solutions do not provide automatic tunneling protocols that are also capable of optimizing deployment as desired protocols become more prevalent.

### SUMMARY OF THE INVENTION

The present disclosure describes an automatic tunneling protocol that is capable of optimizing deployment as network configuration, particularly with regard to deployment of a desired protocol, changes. A network may comprise a first plurality of routers that do not implement a desired protocol. For example, the desired protocol may comprise IP Multicast or any other protocol that presents compatibility problems with existing network protocols, and that may benefit from use of tunneling. At least some of the first plurality of routers are in communication with a second plurality of routers that implement at least the desired protocol and a tunneling protocol. The network may also be logically segregated into multiple domains, with each domain defined by common administration of constituent routers having known connectivity. For purposes of the present disclosure, each domain may be, in accordance with its constituent routers, completely unaware of the desired protocol and the tunneling protocol, completely aware of the desired protocol and only partially aware of the tunneling protocol, or completely aware of both the desired protocol and the tunneling protocol. Routers implementing the tunneling protocol are preferably implemented at the boundaries of domains, i.e., in those routers that serve as interfaces between domains. Similarly, outbound interfaces (i.e., network ports) for a given router implementing the tunneling protocol may be classified as completely aware of the desired protocol or not completely aware of the desired protocol. As the network configuration changes, this state information may be updated. Using this state information, each router can automatically determine whether it is proper to forward a received message in either a format native to the desired protocol or encapsulated using a legacy protocol. Of equal importance, the state information may also inform the decision to disable the tunneling protocol in a given router as deployment of the desired protocol increases. Conversely, if deployment of the desired protocol decreases, the tunneling protocol may be resumed in a given router as necessary. Using this progressive deployment feature, the tunneling protocol in accordance with the instant disclosure maximizes use of the desired protocol while minimizing, in an automatic fashion, use of tunnels.

### BRIEF DESCRIPTION OF THE DRAWINGS

The features described in this disclosure are set forth with particularity in the appended claims. These features and attendant advantages, will become apparent from consideration of the following detailed description, taken in conjunction with the accompanying drawings. One or more embodiments are now described, by way of example only, with reference to the accompanying drawings wherein like reference numerals represent like elements and in which:

FIGS. 1A and 1B illustrate an exemplary network comprising tunnels in accordance with prior art techniques;

FIG. 2 is a schematic block diagram of an exemplary router for use in a network in accordance with the teachings of the instant disclosure;

FIG. 3. is schematic block diagram of a receiver for use with a network in accordance with the teachings of the instant disclosure;

FIG. 4 is a flowchart of processing of a control message by a border router within a leaf-domain of a network in accordance with the teachings of the instant disclosure;

FIG. 5 is a flowchart of processing of a control message by a border router within a core-domain of a network in accordance with the teachings of the instant disclosure; and

FIGS. 6A-6C illustrate various operational states of an exemplary network operating in accordance with the teachings of the instant disclosure.

### DETAILED DESCRIPTION OF THE PRESENT EMBODIMENTS

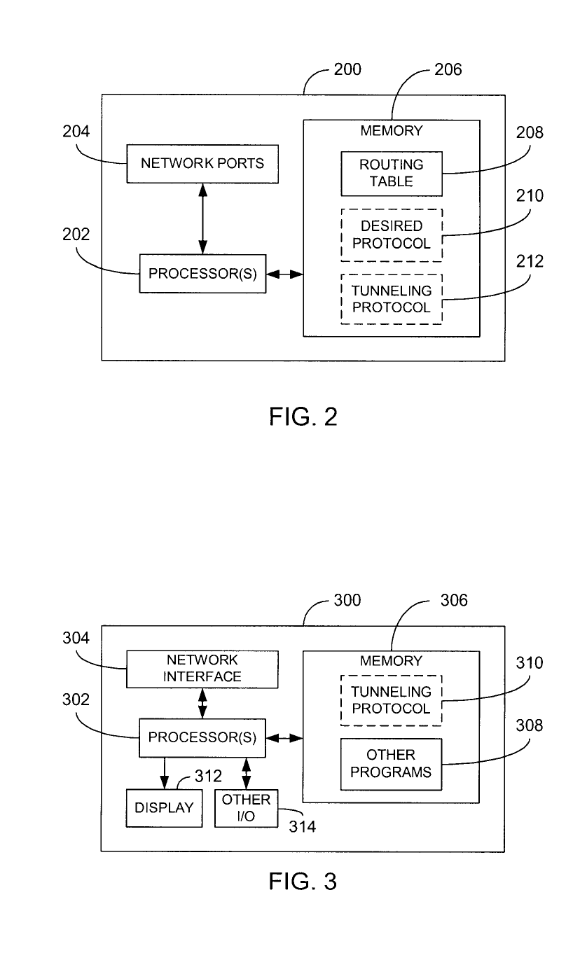

Further understanding of the various features described herein may be developed with reference to the various Figures. Referring now to FIG. 2, a schematic block diagram of an exemplary router 200 is illustrated. In particular, the illustrated router 200 comprises a processor-based device such as a computer (or other suitable device) comprising one or more processors 202 in communication with a plurality of network ports 204 and at least one storage component 206. The processor(s) 202 may comprise microprocessors, microcontrollers, digital signal processors, etc. or combinations thereof operating under the control of executable instructions stored in the storage component(s) 206. The storage component(s) 206 may comprise any combination of volatile/non-volatile memory components such as read-only memory (ROM), random access memory (RAM), electrically erasable programmable read-only memory (EEPROM), etc. The executable instructions stored in the storage component(s) 206 may be particularly used to implement processing as described in greater detail below. In particular, the storage component(s) 206 may include a routing table 208, a desired protocol program 210 and a tunneling protocol program 212. In a presently preferred embodiment, implementation of the tunneling protocol 212 necessarily implies concurrent implementation of the desired protocol 210. However, the opposite is not necessarily true. That is, implementation of the desired protocol 210 isn't always accompanied by implementation of the tunneling protocol 212. Additionally, as known in the art, the router 200 may be implemented, in whole or in part, using components other than software programs, such as ASICs, programmable logic arrays, etc. that may operate under software or hardware control.

As known in the art, the routing table 208 is used by each router 200 to determine the forwarding destination of incoming messages (i.e., data packets). As described in greater detail below, such routing tables can be built in response to routing of specific control messages through the network, although other techniques may also be employed. The network ports 204, as known in the art, each comprise the necessary hardware, firmware and/or software components to allow the router 202 to communicate with other routers, servers, receivers/hosts, etc, i.e., the network. As known in the art, the communication paths between routers or between routers and hosts (or other network components) may comprise many types of communication channels, including wired or wireless channels.

Referring now to FIG. 3, a schematic block diagram of an exemplary host/receiver 300 is illustrated. Such host/receivers 300 in the context of the instant disclosure encompass those devices that communicate with a network and request data and/or services from various sources, e.g., personal computers. In the illustrated example, each of the hosts 300 comprises a processor-based device such as a computer (or other suitable device, such as a personal digital assistant, mobile communication device, etc.) comprising one or more processors 302 in communication with a network interface 304 and at least one storage component 306. As before, the processor(s) 302 may comprise microprocessors, microcontrollers, digital signal processors, etc. or combinations thereof operating under the control of executable instructions stored in the storage component(s) 306. The storage component(s) 306 may comprise any combination of volatile/non-volatile memory components such as ROM, RAM, EEPROM, etc. The executable instructions stored in the storage component(s) 306 may be used to implement a variety of functions, as known in the art. For example, the programs 308 stored in the storage component(s) 306 may include a web browser or other communication interface that allows the host 300 to communicate over the network. Additionally, a tunneling protocol program 310 may also be stored for implementation of the tunneling protocol, as described below. Additionally, as known in the art, the host 300 may be implemented, in whole or in part, using other components such as ASICs, programmable logic arrays, etc. that may operate under software or hardware control.

As further known in the art, the network interface 304 comprises that hardware, firmware and/or software that allows the host 300 to terminate physical links (e.g., Ethernet, wireless, etc.) or communication protocols (e.g., HTTP, SOAP, SSL, TCP/IP, etc.) and thereby communicate with the network. Thus, in an alternative embodiment, and as known in the art, the network interface 304 may implement the tunneling protocol 310 directly, as opposed to the processor(s) 302. Additionally, each host may include a display 312 in communication with the processor(s) 302. As known in the art, the display 312 may comprise an integral or external display such as a cathode-ray tube (CRT), liquid crystal display (LCD), light emitting diode (LED) display, etc. Techniques for providing display data to a display are well known in the art. In a similar vein, each host 300 also preferably includes user input/output components 314, which may include any mechanism that allows a user of the host 300 to interact therewith, e.g., a mouse, keyboard, microphone, video and/or still image camera, speaker, etc. Using such input components, a user of a host 300 may initiate transmission of suitable control signals requiring tunneling functionality as described herein.

As used herein, a domain is a set of routers that are under a common administration with a known connectivity. Routers that are at the border of a domain and serve as gateways to the external network (i.e., outside the domain) are referred to as border routers. Intra-domain routers provide connectivity between the local hosts and border routers. Domains may be further classified into leaf-domains and core-domains. A leaf-domain is typically provided by an organization, such as a business or other enterprise, whose routers service their end hosts by provisioning them connectivity to the broader network, e.g., the Internet. All traffic that enters/leaves a leaf-domain is for/from the local hosts. In contrast, a core-domain, such as would be provided by an Internet Service Provider (ISP) services one or more domains (leaf or core) by routing traffic between them and the remainder of the network, although it is possible that a core-domain may also have local hosts.

As further described below, the tunneling protocol described herein is preferably deployed at the border routers of a domain, whereas intra-domain routers do not need to be aware of the tunneling protocol. Depending on the extent of tunneling protocol and desired protocol deployment among the routers, leaf- and core-domains may be further classified into tunneling-unaware, partial-tunneling-aware and complete-tunneling-aware. As used herein, a router that is “aware” of a protocol implements the protocol. A domain is a complete-tunneling-aware domain if all routers in the domain are aware of the desired protocol and all border routers are additionally aware of the tunneling protocol. A domain is a partial-tunneling-aware domain, if some, but not all, of the border routers are tunneling aware and all routers in the domain are aware of the desired protocol. A domain is tunneling-unaware in all other cases. Thus, note that implementation of the tunneling protocol in a domain's border routers is dependent upon domain-wide implementation of the desired protocol, although the opposite is not necessarily true. The tunneling protocol described herein provides transparent connectivity between hosts and routers residing in complete-tunneling-aware, partial-tunneling-aware and tunneling-unaware domains inter-connected in various topologies between themselves.

In a similar vein to the domains described above, border routers that implement the tunneling protocol may be classified according to the domains to which they belong. Thus a complete-tunneling-border router belongs to a completely-tunneling-aware domain, and a normal-tunneling-border router belongs to any domain that is not a complete-tunneling-aware domain. Similarly, the interfaces (i.e., network ports) of border routers that implement the tunneling protocol may be classified. Thus, an interface of a border router that implements the tunneling protocol is a complete-desired-protocol-aware interface if the interface is an intra-domain interface in either a complete-tunneling-aware or partial-tunneling-aware domain, or if the interface is directly coupled to another router implementing the tunneling protocol.

Finally, it is noted that, in addition to routers, hosts that desire benefit from the desired protocol will be required to implement the tunneling protocol in those instances where their local domain is tunneling-unaware. Alternatively, hosts might be required to implement the tunneling protocol if their local domain is a partial-tunneling-aware domain, and are not required to implement the tunneling protocol if their local domain is a complete-tunneling-aware domain.

A particular feature described herein is the progressive deployment capability of the tunneling protocol. To this end, first time commissioning procedure of tunneling routers is provided. Likewise, a state of each tunneling router is maintained and updated by the router, being responsive to changes in either tunneling or desired protocol awareness in directly connected (i.e., adjacent) routers, thereby making the tunneling protocol self optimizing. As more routers implementing the desired protocol and the tunneling protocol are deployed, use of the desired protocol becomes more optimal, and to reduce overhead, tunneling functionality in a router is disabled automatically when it is no longer necessary for that router to implement the tunneling functionality.

As noted above, first time commissioning of a domain establishes the initial state of each domain, the routers in each domain and the interfaces of the border routers. Thus, states as a complete-tunneling-border router, complete-desired-protocol-aware interface, an intra-domain interface or other interface are configured manually at the time of commissioning by the domain administrator. Status as an intra-domain interface or an external or border-facing interface are not soft states and are configured manually. Designation of border routers as complete-tunneling-border routers and of interfaces as complete-desired-protocol-aware interfaces requires awareness of deployment of the desired protocol and the tunneling protocol states in the local domain. If the awareness is not available, the border routers can be initially commissioned as normal-tunneling-border routers. In implementation, such state information may be stored in suitable storage devices using known techniques.

In a presently preferred embodiment, interfaces of border routers implementing the tunneling protocol periodically issue and, when necessary, respond to tunneling protocol query messages. The format and structure of the tunneling protocol query and response messages is a matter of design choice and the present invention is not limited in this regard. Each interface of a tunneling-border-router periodically issues a query to adjacent router coupled to that interface. If no tunneling protocol query response is received within a time out period, then the interface can ascertain that it is not coupled to a router implementing the tunneling protocol. However, it a tunneling protocol query response is received, then the interface can ascertain that it is coupled to another router implementing the tunneling protocol. Thus, if a new router implementing the tunneling protocol is commissioned connecting directly to an existing tunneling border router, both routers automatically detect and mark their corresponding interfaces as complete-desired-protocol-aware interfaces. Conversely, status as a complete-desired-protocol-aware interface in a border interface is lost if the adjacent router stops responding to the periodic queries. In similar vein, a local (i.e., intra-domain) interface can lose its status as a complete-desired-protocol-aware interface upon failure of the intra-domain router, to which it is coupled, to respond to desired protocol control messages. These desired protocol control messages are part of the desired protocol specifications.

Using these mechanisms, when all border interfaces of a complete-tunneling-border router are connected to tunneling-protocol-aware routers (local interfaces are already complete-desired-protocol aware interfaces), then it can disable its tunneling functionality as it would never receive, as described below, an encapsulated control message and hence does not need to intercept all incoming packets to determine if they are encapsulated (i.e., if they are tunneled). However, the router would continue to exchange tunneling protocol query messages in order identify any state changes or to recover from any failures in its adjacent routers.

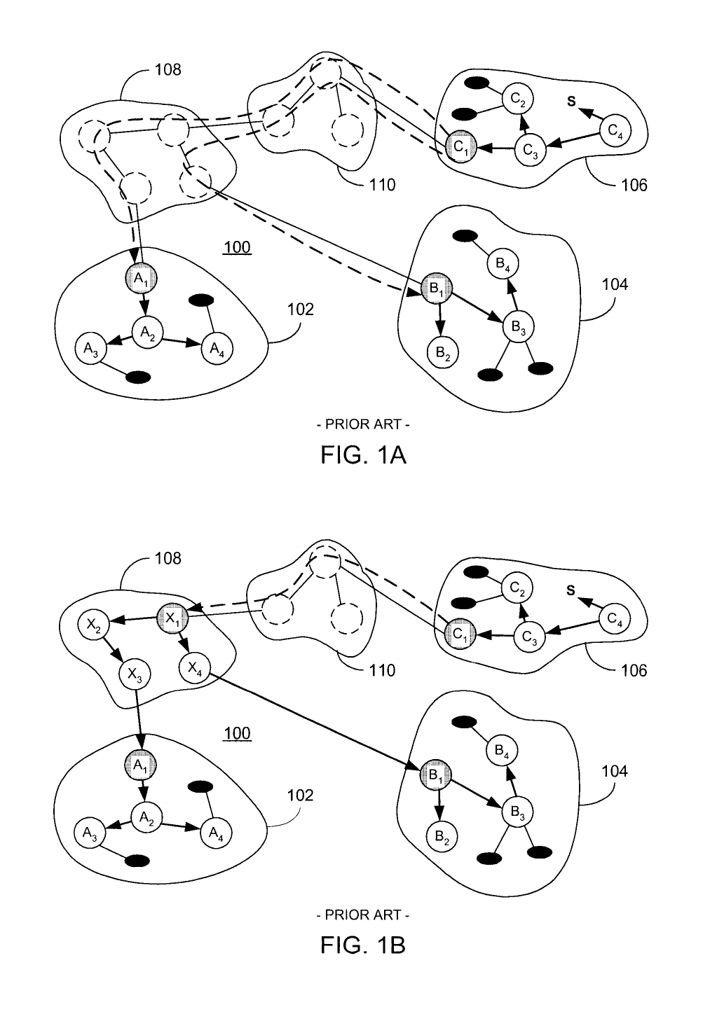

Revisiting FIGS. 1A and 1B and applying the above-described initial commissioning procedure and subsequent state determination, domains A, B and C FIG. 1A would be commissioned as complete-tunneling-aware leaf-domains with routers A₁, B₁ and C₁ being complete-tunneling-border routers. When domain X 108 adopts the desired protocol (i.e., IP multicast in the original example) completely, as in FIG. 1B, it would deploy complete-tunneling-border routers X₁, X₃ and X₄. The border interface at router A₁, on being connected directly to the tunneling border router X₃, becomes a complete-desired-protocol-aware interface. As all of A₁'s intra-domain interfaces are already complete-desired-protocol-aware interfaces, A₁ would disable tunneling functionality and forward IP multicast packets natively to X₂. Similar actions are taken by router B₁. Thus, the tunneling protocol has automatically expanded the borders of the new IP multicast “islands” to the edge of domain X from the edges of domains A and B. In turn, this reduces the overhead with sending packets from the source, S, to multiple receivers in the leaf-domains A, B and C.

It should be noted that, for best performance, two additional routers (X₃ and X₄) implementing the tunneling protocol were required in domain X. However, the tunneling protocol would still be operational with only X₁ as a border router, i.e., making domain X a partial-tunneling-aware domain. With only a single tunneling border router, the tunnel connectivity would include three tunnels: one from C₁ to X₁ and one each from X₁ to A₁ and B₁. This is comparable to AMT which requires only one router (say, X₁) to be commissioned as an AMT gateway.

As described above, so-called control plane functionality of the tunneling protocol provides the ability to progressively deploy the tunneling protocol. Of course, it is also necessary to correctly route messages (i.e., packets) using the tunnels and, where possible, the desired protocol. To this end, the tunneling protocol provides for routing table construction. In a presently preferred embodiment, and building on the example of IP multicast, routing table construction is reverse shortest path from the root or core of the multicast tree. However, as will be appreciated by those of skill in the art, the instant techniques may be applied to desired protocols other than IP Multicast and, equally important, the present techniques may employ other routing table construction techniques as a matter of design choice. As known in the art, some IP multicast operations are premised on the establishment of a group, G, to receive the multicast data from the source, S. Thus, in a source specific IP multicast scenario, a host or receiver may request to join a group through transmission of a join message, J(S,G), to the multicast source. Using the instant tunneling protocol, two kinds of routes are possible for data sent to a group in a tunneling router, i.e., interface routing and unicast routing. In the former, IP multicast routing entries are designated by a set of output interfaces whereas, in the latter, tunneling routes are defined by a set of next hop unicast destination addresses corresponding to the group address G. That is, while IP multicast routes typically point towards intra-domain interfaces of the router, the tunneling routes are to destinations in external domains requiring unicast addressing. In the case of unicast addressing, it is required to know the unicast destination for the control message to be encapsulated, i.e., multicast control messages. In this latter case, the tunneling router retrieves this information from the header of received IP multicast control messages. (It is noted that, in the case of IP multicast, two types of multicasting may be implemented, which may affect the identity of the multicast source. Thus, in the case of single-source multicasting (SSM), the destination to receive a control (join) message is the source itself, whereas in the case of any-source multicasting (ASM), the destination is the address of the so-called rendezvous point (RP), as known in the art.)

Tunneling border routers inspect incoming unicast (i.e., legacy) messages to determine whether they are encapsulated messages. In a presently preferred embodiment, this is accomplished through the use of a protocol number field available in the encapsulating header. That is, the protocol number field can be used to indicate that the received unicast message is not a “typical” unicast message, but is desired protocol message that has been encapsulated. As described below, if the necessary criteria are met, the tunneling border router can use this information to either de-capsulate the message or to continue routing the message in its encapsulated form. Of course, when a message is encapsulated by a border router in the first instance, the protocol number field is appropriately set to indicate to the receiving tunneling border router that the message is in fact an encapsulated message. As will be appreciated by those having ordinary skill in the art, mechanisms other than the protocol number field may be equally employed for these purposes.

As set forth below, various rules may be employed to guide the construction of routing tables and, consequently, encapsulation/de-capsulation decisions, based on IP multicast control messages. Such rules may be divided into two categories, those concerning leaf-domains and those concerning core-domains. In all cases (leaf- or core-domains), two directly connected tunneling routers always communicate using the desired protocol, e.g., IP multicast control messages. In the case of leaf-domains only, all tunneling border routers, on receiving a desired protocol control message, typically originated from within the domain and destined for locations outside the domain, encapsulate the control message (e.g., into a unicast packet) only when the outgoing interface for the packet is not a complete-desired-protocol-aware interface. On receiving an encapsulated control message, typically inbound to the domain and originated from outside the domain, all tunneling border routers de-capsulate if the domain is a complete-tunneling-aware domain. If the domain is a partial-tunneling-aware domain, then if the message is to be forwarded on a complete-desired-protocol-aware interface it is de-capsulated; otherwise, the message is forwarded in its encapsulated form.

In the case of core-domains that are tunneling-unaware, encapsulated messages are never de-capsulated. On the other hand, in complete-tunneling-aware core-domains, all incoming encapsulated control messages are converted to control messages in the native format of the desired protocol, e.g., an IP multicast control messages. In the case of a partial-tunneling-aware core-domain, when a tunneling border router receives an encapsulated control message on a border interface, it is necessary to determine whether the control message is addressed to an intra-domain or inter-domain destination. In the case of an intra-domain destination, if the message is to be forwarded on a complete-desired-protocol-aware interface, the encapsulated message is de-capsulated into the native format of the desired protocol prior to forwarding. If either the domain is not complete-tunneling-aware or the destination within the domain cannot be determined, then the message is forwarded towards its destination in its encapsulated form (unless the interface to be forwarded-to is connected to a router's tunneling aware interface). As known in the art, destination identities can usually be established by referring to the unicast routing tables. Alternatively, the intra-domain network identity can be specified at the time of commissioning.

Upon receiving a desired protocol control message in its native format, a router in any domain other than a complete-tunneling-aware domain will decide whether to encapsulate the native control message based on substantially the same criterion as above, i.e. if the destination of the control message is intra-domain and the message is to be forwarded on a complete-desired-protocol-aware interface, it is forwarded in its native state, but if either the domain is not a complete-tunneling-aware domain or the destination is not within the domain, then the message is encapsulated and forwarded to its destination.

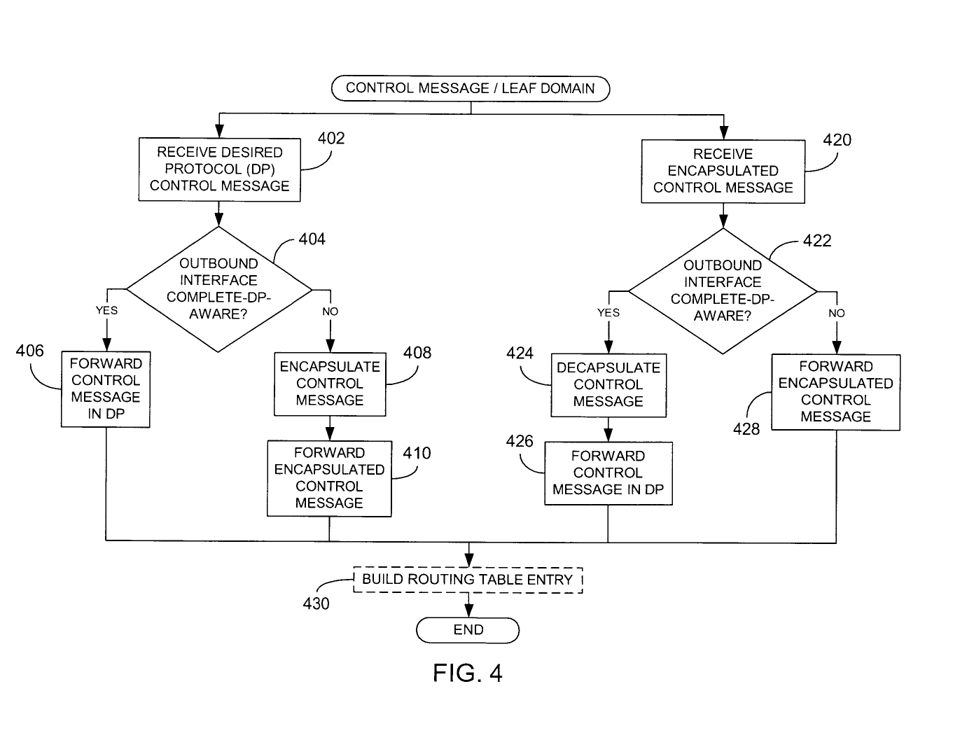

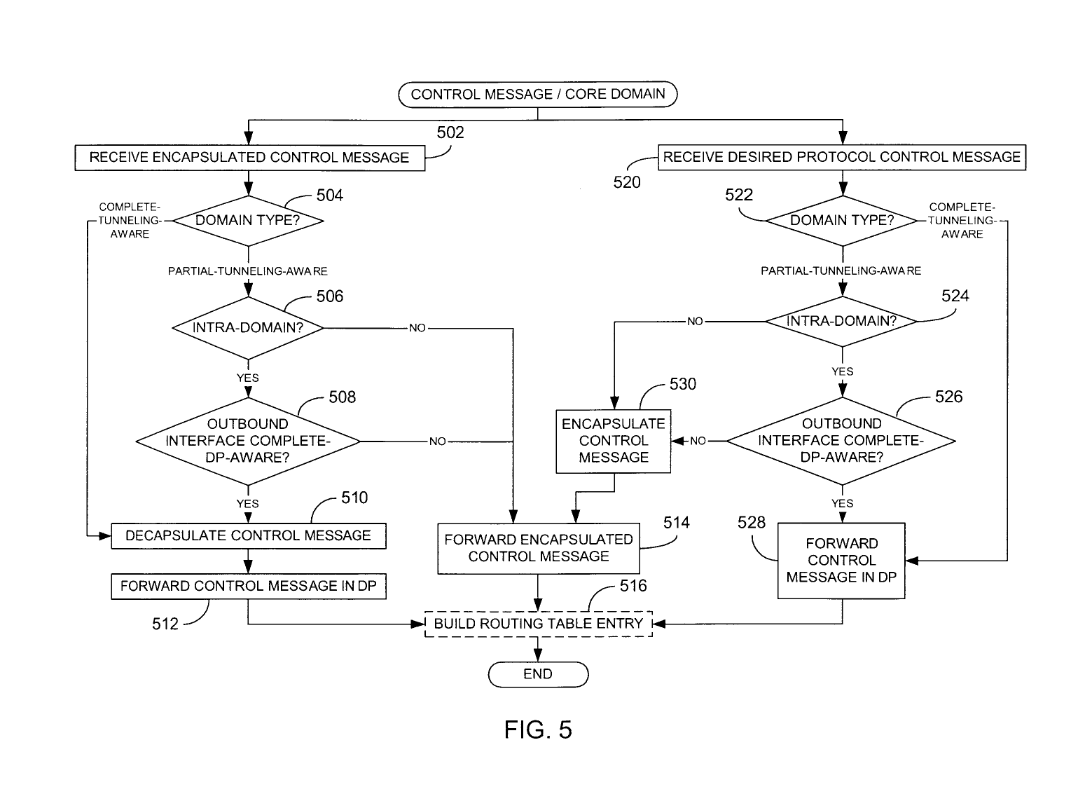

The rules described above concerning handling of control messages (either in encapsulated or native form) within leaf and core-domains are further summarized with reference to FIGS. 4 and 5. In a presently preferred embodiment, the processing of FIGS. 4 and 5 is carried out using executable instructions stored on a suitable storage device that are executed by a one or more processors, e.g., by a computer or similar device, particularly a tunneling border router. However, as known to those having skill in the art, other techniques (e.g., hardware, firmware or combinations thereof) may be used to implement the processing of FIGS. 4 and 5 in whole or in part.

Referring now to FIG. 4, a flow chart illustrating processing of control messages by a leaf-domain is further illustrated. At block 402, a control message in the native format of the desired protocol is received. Thereafter at block 404, is determined whether an outbound interface for the control message is a complete-desired-protocol-aware interface. If so, processing continues at block 406 where the control message is forwarded to its destination in the native format of the desired protocol. However, if the outbound interface is not a complete-desired-protocol-aware interface, processing continues at block 408 where the native format control message is encapsulated. Thereafter at block 410, the encapsulated control message is forwarded to the original destination of the native format control message.

Alternatively, at block 420, the tunneling router receives an encapsulated control message. Once again, it is determined at block 422 whether the outbound interface for the encapsulated control message is a complete-desired-protocol-aware interface. If not, processing continues at block 428 where the encapsulated control message is forwarded via the outbound interface to its destination. On the other hand, if the outbound interface is a complete-desired-protocol-aware interface, processing continues at bock 424 where the control message is first de-capsulated and subsequently forwarded in the native format of the desired protocol at block 426. Note that, regardless of the manner in which the control message is forwarded on by the leaf-domain, routing table entries are created at block 430.

Referring now to FIG. 5, a flow chart illustrating processing of control messages by core-domain routers is further illustrated. Beginning at block 502, a router within a core-domain receives an encapsulated control message. At block 504, it is determined whether the domain in which the router resides is a partial-tunneling-aware domain or a complete-tunneling-aware domain. Note that state information such as domain type (or router or interface types, as described above) is preferably maintained by each router. If the domain type is a complete-tunneling-aware domain, processing continues at block 510 where the message is de-capsulated and subsequently forwarded, at block 512, in its native form. If, at block 504, it is determined that the domain is a partial-tunneling-aware domain, processing continues at block 506 where it is further determined whether the destination for the control message is intra-domain or inter-domain. If the destination of the message is not intra-domain (i.e., that the message is destined for another domain), then processing continues at block 514 where the encapsulated control message is forwarded on to its destination. If the control message is targeted to an inter-domain destination, processing continues at block 508 where it is determined whether the outbound interface upon which the message is to be routed is a complete-desired-protocol-aware interface. Once again, if the outbound interfaces is not complete-desired-protocol-aware, processing continues at block 514 where the encapsulated control message is forwarded on. Alternatively, if the outbound interface is a complete-desired-protocol-aware interface, processing continues at block 510 where the control message is de-capsulated and, at block 512, subsequently forwarded to its destination in its native form.

If a tunneling border router within a core-domain receives a control message in its native format, as illustrated by block 520, processing continues at block 522 where the domain type is once again determined. If the domain type is a complete-tunneling-aware domain, processing continues at block 528 where the control message is forwarded in its native format. If, however, the domain is a partial-tunneling-aware domain, processing continues at block 524 where it is determined whether the destination of the control message is intra-domain or inter-domain. As before, if the destination of the control message is not intra-domain, processing continues at block 530 where the control message is first encapsulated and subsequently, at block 514, forwarded on to its destination outside the domain. If the destination of the control message is intra-domain, processing continues at block 526 where it is again determined whether or not the outbound interface is a complete-desired-protocol-aware interface. If the outbound interface is not a complete-desired-protocol-aware interface, processing continues at block 530 where the message is encapsulated and subsequently forwarded to its destination at block 514. If the outbound interface is a complete-desired-protocol-aware interface, processing continues at block 528 where the control message is forwarded to its destination in its native format. Once again, in all instances, subsequent to forwarding control messages to their destinations, processing continues at block 516 where routing table entries are built.

As described above, rules are provided for the handling of control messages by tunneling aware border routers. Similarly, rules are provided for the handling of data messages. Routing of data messages is achieved through the use of routing tables that specify an outbound interface for any inbound packets. In the case of a tunneling aware border router, the routing table may comprise table entries for the handling of both data messages in the native format of the desired protocol as well as encapsulated messages if it is required that packets be forwarded as both native multicast and ITP data packets. Such a scenario arises in a core-domain that is a complete-tunneling-aware domain or a partial-tunneling-aware domain and that also includes intra-domain receivers that are targeted to receive the data. In this case, the routing entries concerning packets in native format are provided for traffic terminating within the local domain, whereas table entries concerning encapsulated packets are provided for packets destined for remote domains. Additionally, encapsulated data packets are intercepted by a tunneling aware border router only if the destination of the packet is the router's local interface address. Other routers would forward the data packets to its destination according to their unicast routing tables.

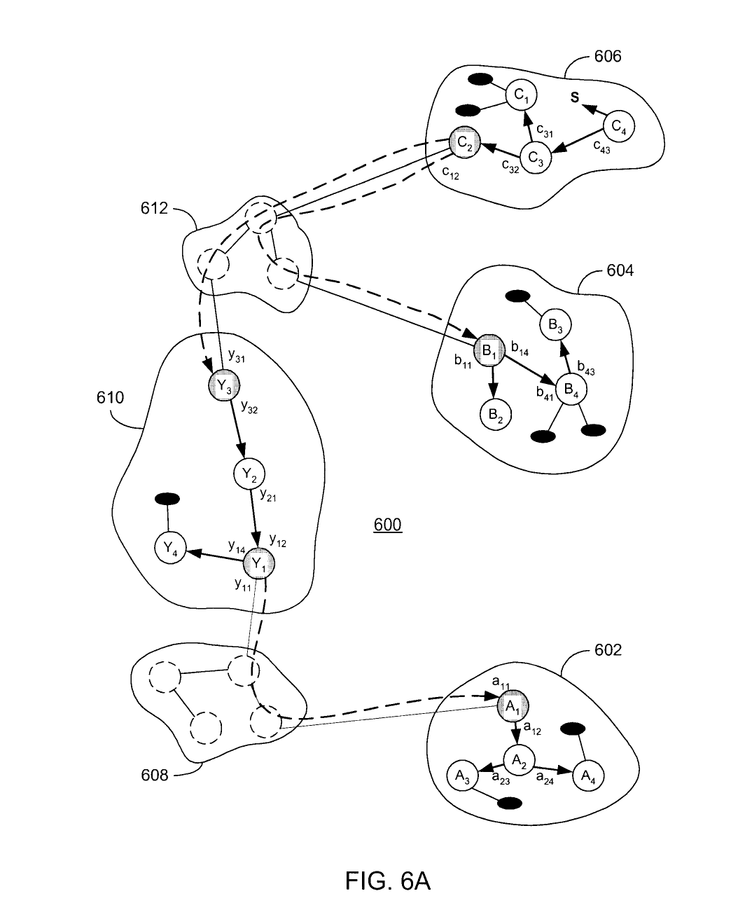

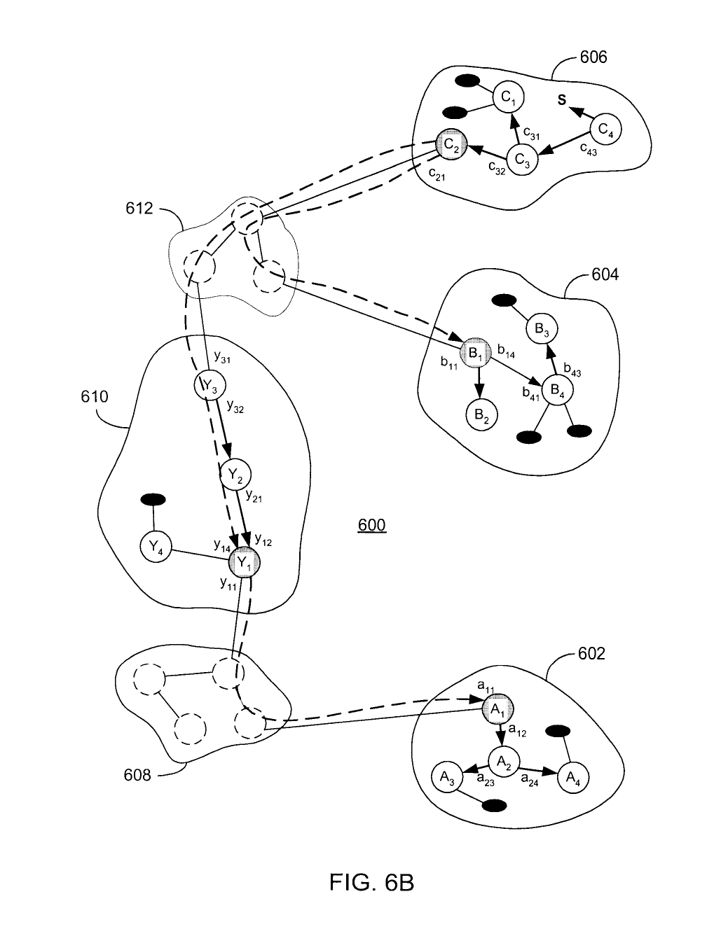

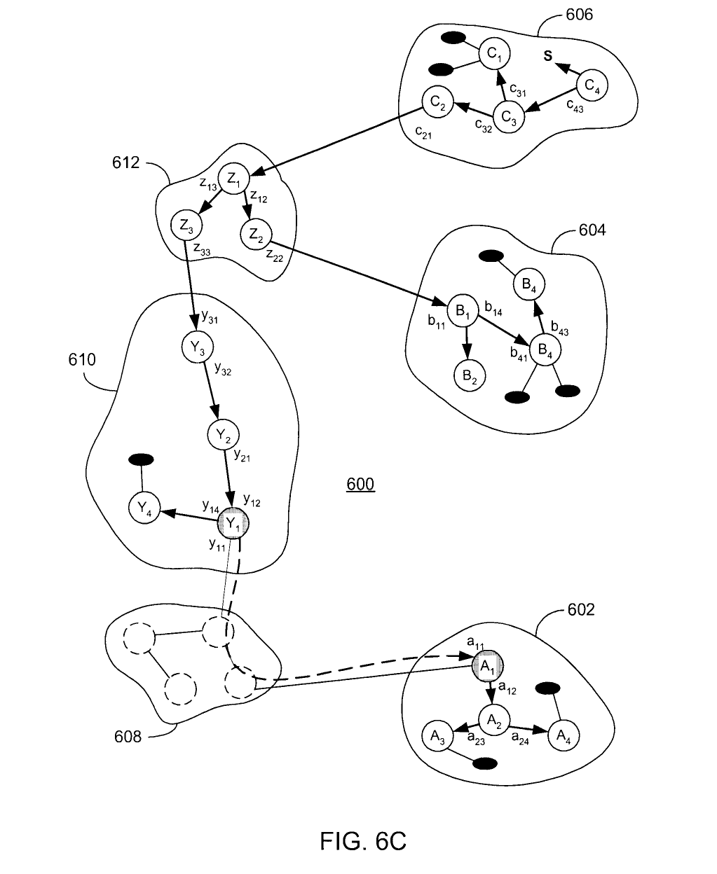

Further understanding of the tunneling protocol and construction of routing tables is provided with reference to the various examples illustrated in FIGS. 6A-C. As before, each of the examples illustrated in FIGS. 6A-C are with regard to IP multicast as the desired protocol. Thus, in these examples, the tunneling protocol is provided to extend IP multicast by carrying control and data messages over unicast routers. In this instance, the IP multicast control messages, e.g., Protocol Independent Multicast-Sparse Mode (PIM-SM) join and leave messages, are encapsulated with a unicast IP header.

FIG. 6A illustrates an exemplary network 600, comprising a plurality of leaf-domains 602-606, also labeled A, B and C as shown. Inter-leaf-domain communications are supported by core-domains 608-612 of which, one domain 610 is labeled Y as shown. In this example, each of the leaf-domains A-C, as well as the core-domain Y, is completely multicast aware, and routers Y₁, Y₃, A₁, B₁ and C₂ are border routers implementing the tunneling protocol. The remaining core-domains 608, 612 do not implement multicast. Operation of the presently-described tunneling protocol is further illustrated through description of a source-specific multicast (SSM) connection setup with the multicast sender in domain C and receivers in domains A and B.

To begin, the receivers (black ovals) in domain A initiate a multicast join using, for example, PIM-SM control messaging via their designated routers, A₃ and A₄, thus initiating routing tree construction within domain A. The join messages J(S,G) (where S is the multicast source and G is the group address of the multicast group) are sent by the designated routers A₃ and A₄ that create a multicast routing state (i.e., multicast routing entries in corresponding routing tables) in routers A₂ with a₂₃ and a₂₄ as the output interfaces for (S,G). Table 1 below illustrates the various routing table entries in the illustrated routers in the order in which they are created in accordance with this example. Note that entries preceded by the asterisk (*) correspond to routing table entries defined according to the format of the desired protocol, i.e., the IP multicast protocol, whereas table entries without asterisks are defined according to the tunneling protocol, i.e., encapsulation with unicast headers.

After interception by router A₂, the multicast join message is forwarded and reaches router A₁ on its way to the multicast source S. Router A₁, on receiving the join message on a complete-multicast-aware interface and to be forwarded on its border interface (a₁₁ that, in this instance is not a complete-multicast-aware interface) encapsulates the multicast join message in a unicast header with unicast address of the border interface a₁₁ in the source and the multicast source S in destination address fields. The encapsulated join message is subsequently intercepted by the complete-tunneling-aware border router Y₁. In building a routing table entry, the router Y₁ adds the unicast address of interface a₁₁ as its next hop address for the group (S, G). Additionally, router Y₁ extracts (de-capsulates) the multicast join message and propagates it towards the source S via intra-domain router Y₂. Router Y₂ creates a multicast routing state for the group (S,G) designating interface y₂₁ as the outgoing interface. At border router Y₃, interface y₃₂ is added as the outgoing interface in the multicast routing state. Border router Y₃ again converts the multicast join message into an encapsulated message designating interface y₃₁ as the source and multicast source S as the destination address of the unicast packet. The encapsulated join message, when received at tunneling border router C₂, is again converted to a native multicast join message and initiates an intra-domain routing tree rooted at the multicast source S. Router C₂ also establishes a routing table entry in which the unicast address of interface y₃₁ as designated as the next hop router for data targeted to the group (S,G).

Similarly, receivers in domain B initiate multicast join messages leading to an intra-domain routing tree as shown in Table 1. The multicast joins are converted to encapsulated join messages at router B₁ with interface b₁₁ as the source and multicast source S is the destination. The encapsulated join is subsequently intercepted at router C₂, which adds unicast address of interface b₁₁ as its next hop unicast router for the group (S,G). Note that, by virtue of the join message originated by domain A, interface c₃₂ is already part of the intra-domain tree within domain C. Multicast leave and other control messages can be transported using this tunneling protocol in the similar fashion.

Finally, as previously noted, it is possible for core-domains to also support local hosts. This is illustrated in FIG. 6A where router Y₄ in domain Y also passes on a multicast join message resulting in the additional multicast routing state within router Y₁ as illustrated in Table 1 below.

TABLE 1

| Router | Routing Table Entry |
|---|---|
| A₂ | *S\|G\|a₂₃\|a₂₄ |
| A₁ | *S\|G\|a₁₂ |
| Y₁ | *S\|G\|y₁₄ |
| | S\|G\|ua₁₁ |
| Y₂ | *S\|G\|y₂₁ |
| Y₃ | *S\|G\|y₃₂ |
| C₂ | S\|G\|uy₃₁\|ub₁₁ |
| C₃ | *S\|G\|c₃₂\|c₃₁ |
| C₄ | *S\|G\|c₄₃ |
| B₄ | *S\|G\|b₄₃ |
| B₁ | *S\|G\|b₁₄ |

Using the routing table entries illustrated in Table 1, data sent by the source S can be most efficiently routed to the receivers that have joined the group (S,G). Thus, a data packet sent by source S arrives at router C₄ and, based on its routing table, forwards the data packet (all other similar and subsequently received data packets) through its c₄₃ interface, i.e., towards router C₃. The multicast routing entry in router C₃ causes the data packet to be duplicated by the router and sent out its interfaces C₃₁, and c₃₂. The packet received by router C₁ (i.e., sent via interface c₃₁) is then provided to its local receiver. On the other hand, the packet received by router C₂ is encapsulated and addressed to the respective interfaces (uy₃₁ and ub₁₁) of routers Y₃ and B₁. At router B₁, the encapsulated message is de-capsulated and sent through the intervening routers B₄ and B₃ to the necessary receivers as described above.

Likewise, at router Y₃, the encapsulated message is de-capsulated and sent through the intervening routers Y₂, Y₁ and Y₄ to the receiver within domain Y. However, at router Y₁, the now-de-capsulated message is once again encapsulated and addressed to the interface (ua₁₁) of router A₁. Upon receiving the encapsulated message, router A₁ again de-capsulates the message for routing to the necessary receivers via routers A₂-A₄. In this manner, the previously-established routing table entries are able to maximize the efficiencies provided by the multicast protocol where possible, while still relying on tunnels when necessary.

Further reference is now made to FIG. 6B where domain Y is now illustrated as a partial-tunneling-aware domain, in addition to the previously-described complete-tunneling-aware (i.e., domains A-C) and tunneling unaware domains. Note the domain Y is a partially tunneling aware domain in the example of FIG. 6B because router Y₃ is no longer tunneling aware (although, like the other routers in domain Y, it remains multicast aware).

IP multicast routes in domain A are identical to those described in the previous example and as shown in Table 2 below. As the encapsulated join message sent by router A₁ is intercepted by the tunneling border router Y₁, it is not de-capsulated into a native multicast join message because Y₁ is not a complete-tunnelling-aware router, and a routing table entry for group (S,G) is created with the IP address of interface a₁₁ as the next hop. The still-encapsulated join message is forwarded towards its original destination, multicast source S, passing transparently through the intervening routers, and subsequently reaching router C₂. At router C₂ the multicast routing state for group (S,G) has as its next hop the address of interface y₁₂. Receivers from domain B join the group (S,G) in the same manner as described in the previous example, resulting in the final routing states set forth in Table 2.

Note that, in the example of FIG. 6B, receivers in domain Y are able to join the group (S,G) only if they have router Y₁ a tunneling aware router in its path to the source S. For example if a host connected to Y₄ sends a join message to the source S, router Y₄ forwards the message to router Y₁, and router Y₁ will encapsulate the join message (since the destination of the join message, i.e. source S, is in remote domain and domain Y is a partial-tunneling-aware domain) and send it towards source S. But if a host connected to router Y₂ were to initiate a join message, the join message will be forwarded by router Y₂ to router Y₃, which will drop the join message since its adjacent domain 612 is multicast-unaware and since router Y₃ itself doesn't implement the tunneling protocol. Alternatively, if the host connected to router Y₂ implements the tunnel protocol itself (see FIG. 3, tunneling program 310), the host can originate its own encapsulated join message that would result in the host address being added as a next hop unicast address in router C₂ for the group (S,G). In this same vein, it is noted that, for a receiver in a tunneling unaware domain, the receivers would also be required to originate encapsulated join messages.

TABLE 2

| Router | Routing Table Entry |
|---|---|
| A₂ | *S\|G\|a₂₃\|a₂₄ |
| A₁ | *S\|G\|a₁₂ |
| Y₁ | *S\|G\|y₁₄ |
| | S\|G\|ua₁₁ |
| Y₂ | — |
| Y₃ | — |
| C₂ | S\|G\|uy₁₂\|ub₁₁ |
| C₃ | *S\|G\|c₃₂\|c₃₁ |
| C₄ | *S\|G\|c₄₃ |
| B₄ | *S\|G\|b₄₃ |
| B₁ | *S\|G\|b₁₄ |

Yet another example is illustrated in FIG. 6C where it is assumed that the initial configuration of the network 600 is identical to that illustrated in FIG. 6A. However, as shown in FIG. 6C, it is further assumed that multicast functionality is subsequently deployed in domain Z 612. In accordance with the techniques described above, each of domain Z's border routers Z₁, Z₂ and Z₃ would also implement the instant tunneling protocol. As a result, tunneling protocol query messages and responses would be exchanged between the domain Z border routers Z₁, Z₂ and Z₃ and their corresponding adjacent, inter-domain routers C₂, B₁ and Y₃, respectively. As a result, each of these routers would become complete-tunneling-border routers, capable of relying solely on multicast routing, and subsequently disable their tunneling functionality, as shown. As a result, the number of tunnels required would be reduced to a single tunnel between domains A and Y, with the routing table entries as shown in Table 3 below.

TABLE 3

| Router | Routing Table Entry |
|---|---|
| A₂ | *S\|G\|a₂₃\|a₂₄ |
| A₁ | *S\|G\|a₁₂ |
| Y₁ | *S\|G\|y₁₄ |
| | S\|G\|ua₁₁ |
| Y₂ | *S\|G\|y₂₁ |
| Y₃ | *S\|G\|y₃₂ |
| Z₃ | *S\|G\|z₃₃ |
| Z₁ | *S\|G\|z₁₃\|z₁₂ |
| Z₂ | *S\|G\|z₂₂ |
| C₂ | *S\|G\|c₂₁ |
| C₃ | *S\|G\|c₃₂\|c₃₁ |
| C₄ | *S\|G\|c₄₃ |
| B₄ | *S\|G\|b₄₃ |
| B₁ | *S\|G\|b₁₄ |

Note that, as in the example of Table 1, the routing table entries illustrated in Tables 2 and 3 may be utilized in the same manner to route subsequent data messages from the source S to the necessary receivers in the most efficient manner possible based on maximum possible usage of the multicast protocol.

As described above, a technique for automatic network tunneling and, equally importantly, progressive deployment is provided. To this end, tunneling-aware border routers within various domains are capable of determine whether adjacent routers are likewise tunneling-aware. If so, the border routers can rely on the desired protocol, rather than explicit tunnels, and may subsequently disable their tunneling protocol functionality. Based on routing states created in this manner, data messages may be appropriately routed through the network using tunnels only where necessary. For at least these reasons, the instant disclosure describes techniques that represent an advancement over prior art techniques.

While the particular preferred embodiments of the present invention have been shown and described, it will be obvious to those skilled in the art that changes and modifications may be made without departing from the teachings of the invention. It is therefore contemplated that the present invention cover any and all modifications, variations or equivalents that fall within the scope of the basic underlying principles disclosed above and claimed herein.

What is claimed is:

1. In a network comprising interconnected routers in which a first plurality of routers do not implement a desired protocol and a second plurality of routers implement at least the desired protocol and a tunneling protocol, a method in a router of the second plurality of routers for optimizing deployment of the tunneling protocol, the method comprising:
determining, by the router, that the desired protocol and the tunneling protocol is operational in all routers adjacent to the router; and
disabling, by the router, operation of the tunneling protocol when the tunneling protocol is operational in all routers adjacent to the router.

2. The method of claim 1, wherein determining that the desired protocol and the tunneling protocol are operational in all routers adjacent to the router further comprises receiving messages from routers adjacent to the router indicating that the tunneling protocol is operational.

3. The method of claim 1, further comprising:
determining, by the router, that the tunneling protocol is not operational in at least one adjacent router; and
resuming, by the router, operation of the tunneling protocol when the tunneling protocol is not operational in the at least one adjacent router.

4. The method of claim 3, wherein determining that the tunneling protocol is not operational in the at least one adjacent router further comprises failing to receive, within a period of time, messages from the at least one adjacent router indicating that the tunneling protocol is operational in the at least one adjacent router.

5. The method of claim 1, further comprising, subsequent to disabling operation of the tunneling protocol:
monitoring whether the desired protocol and the tunneling protocol continue to be operational in all routers adjacent to the router.

6. A router for use in network comprising interconnected routers, the router implementing a desired protocol and a tunneling protocol and further comprising:
a plurality of network ports operative to support communications with other ones of the routers;
at least one processor coupled to the plurality of network ports;
at least one storage device coupled to the at least one processor and having stored thereon executable instructions that, when executed by the at least one processor, cause the at least one processor to:
determine that the desired protocol and the tunneling protocol are operational in all routers adjacent to the router; and
disable operation of the tunneling protocol when the tunneling protocol is operational in all routers adjacent to the router.

7. The router of claim 6, wherein the executable instructions operative to determine that the desired protocol and the tunneling protocol are operational in all routers adjacent to the router further comprise executable instructions that, when executed by the at least one processor, further cause the at least one processor to receive, via the plurality of network ports, messages from routers adjacent to the router indicating that the tunneling protocol is operational.

8. The router of claim 6, wherein the at least one storage device further comprises executable instructions that, when executed by the at least one processor, cause the at least one processor to:
determine that the tunneling protocol is not operational in at least one adjacent router; and
resume operation of the tunneling protocol when the tunneling protocol is not operational in the at least one adjacent router.

9. The router of claim 8, wherein the executable instructions operative to determine that the tunneling protocol is not operational in the at least one adjacent router further comprise executable instructions that, when executed by the at least one processor, further cause the at least one processor to determine that messages from the at least one adjacent router indicating that the tunneling protocol is operational in the at least one adjacent router are not received within a period of time.

10. The router of claim 6, wherein the at least one storage device further comprises executable instructions that, when executed by the at least one processor, cause the at least one processor to, subsequent to disabling operation of the tunneling protocol:
monitor whether the desired protocol and the tunneling protocol continue to be operational in all routers adjacent to the router.

11. The router of claim 6, wherein the router is a border router in a domain of the network.

12. In a network comprising interconnected routers in which a first plurality of routers do not implement a desired protocol and a second plurality of routers implement at least the desired protocol and a tunneling protocol, a method in a router of the second plurality of routers for routing a control message, the method comprising:
receiving a control message in a format native to the desired protocol;
determining whether an outbound interface through which the control message is to be forwarded is complete-desired-protocol-aware interface; and
when the outbound interface is a complete-desired-protocol-aware interface, forwarding the control message via the outbound interface in the format native to the desired protocol.

13. The method of claim 12, further comprising:
when the outbound interface is not a complete-desired-protocol-aware interface, encapsulating the control message to provide an encapsulated control message, and forwarding the encapsulated control message via the outbound interface.

14. A router for use in network comprising interconnected routers, the router implementing a desired protocol and a tunneling protocol and further comprising:
a plurality of network ports operative to support communications with other ones of the routers;
at least one processor coupled to the plurality of network ports;
at least one storage device coupled to the at least one processor and having stored thereon executable instructions that, when executed by the at least one processor, cause the at least one processor to:
receive a control message in a format native to the desired protocol;
determine whether an outbound interface through which the control message is to be forwarded is a complete-desired-protocol-aware interface; and
when the outbound interface is a complete-desired-protocol-aware interface, forward the control message via the outbound interface in the format native to the desired protocol.

15. The router of claim 14, wherein the at least one storage device further comprises executable instructions that, when executed by the at least one processor, cause the at least one processor to:
when the outbound interface is not a complete-desired-protocol-aware interface, encapsulate the control message to provide an encapsulated control message; and
forward the encapsulated control message via the outbound interface.

16. The router of claim 14, wherein the router is a border router in a domain of the network.

17. In a network comprising interconnected routers in which a first plurality of routers do not implement a desired protocol and a second plurality of routers implement at least the desired protocol and a tunneling protocol, a method in a router of the second plurality of routers for routing an encapsulated control message, the method comprising:
receiving the encapsulated control message;
determining whether an outbound interface through which the encapsulated control message is a complete-desired-protocol-aware interface; and
when the outbound interface is not a complete-desired-protocol-aware interface, forwarding the control message in encapsulated form.

18. The method of claim 17, further comprising:
when the outbound interface is a complete-desired-protocol-aware interface, de-capsulating the control message to provide a control message in a format native to the desired protocol, and forwarding the control message via the outbound interface in the format native to the desired protocol.

19. A router for use in network comprising interconnected routers, the router implementing a desired protocol and a tunneling protocol and further comprising:
a plurality of network ports operative to support communications with other ones of the routers;
at least one processor coupled to the plurality of network ports;
at least one storage device coupled to the at least one processor and having stored thereon executable instructions that, when executed by the at least one processor, cause the at least one processor to:
receive an encapsulated control message;
determine whether an outbound interface through which the encapsulated control message is to be forwarded is a complete-desired-protocol-aware interface; and
when the outbound interface is not a complete-desired-protocol-aware interface, forwarding the control message in encapsulated form.

20. The router of claim 19, wherein the at least one storage device further comprises executable instructions that, when executed by the at least one processor, cause the at least one processor to:
when the outbound interface is a complete-desired-protocol-aware interface, de-capsulate the control message to provide a control message in a format native to the desired protocol; and
forward the control message via the outbound interface in the format native to the desired protocol.

21. The router of claim 19, wherein the router is a border router in a domain of the network.

22. A system comprising:
a first plurality of routers that do not implement a desired protocol; and
a second plurality of routers that implement at least the desired protocol and a tunneling protocol, at least a portion of the second plurality of routers in communication with at least a portion of the first plurality of routers,
wherein each router of the portion of the second plurality of routers is operative to disable operation of the tunneling protocol when the tunneling protocol is operational in all routers adjacent to the router, and to resume operation of the tunneling protocol when the tunneling protocol is not operational in the at least one router adjacent to the router.

23. In a network comprising interconnected routers in which a first plurality of routers do not implement a desired protocol and a second plurality of routers implement at least the desired protocol and a tunneling protocol, a method for routing a data message targeted to a group address, the method comprising:
prior to receiving the data message, creating, in each routing table within each router of a set of the second plurality of routers, a corresponding routing table entry comprising the group address, a source address and at least one next-hop-destination, wherein the at least one next-hop destination comprises either of at least one outbound interface number or at least one destination address; and
routing the data message to receivers coupled to the network based on the corresponding table entry in each router of the set of the second plurality of routers.

24. The method of claim 23, further comprising, within a router of the set of the second plurality of routers:
receiving a data message, corresponding to the group address, in a format native to the desired protocol;
identifying the table entry comprising the group address;
identifying each of the at least one next-hop destination based on the table entry; and
forwarding the data message to each of the at least one next-hop destination.

25. The method of claim 24, wherein forwarding the data message to each of the at least one next-hop destination further comprises forwarding the data message based on the at least one outbound interface number.

26. The method of claim 24, wherein forwarding the data message to each of the at least one next-hop destination further comprises:
encapsulating the data message to provide an encapsulated data message; and
forwarding the encapsulated data message based on the at least one destination address.

27. The method of claim 23, further comprising, within a router of the set of the second plurality of routers:
receiving an encapsulated data message comprising a destination address that does not correspond to a local interface of the router;
forwarding the encapsulated data message to the destination address included in the encapsulated data message.

28. The method of claim 23, further comprising, within a router of the set of the second plurality of routers:
receiving an encapsulated data message comprising a destination address that corresponds to a local interface of the router;
determining that the encapsulated data message corresponds to the group address;
identifying the table entry comprising the group address;
identifying each of the at least one next-hop destination based on the table entry;
when one of the at least one next-hop destination address is an outbound interface number, de-capsulating the encapsulated data message to provide the data message in a format native to the desired protocol; and
forwarding the data message to the outbound interface number.

29. The method of claim 23, further comprising, within a router of the set of the second plurality of routers:
receiving an encapsulated data message comprising a destination address that corresponds to a local interface of the router;
determining that the encapsulated data message corresponds to the group address;
identifying the table entry comprising the group address;
identifying each of the at least one next-hop destination based on the table entry;
when one of the at least one next-hop destination address is a destination address, modifying the encapsulated data message to change the destination address; and
forwarding the data message to the destination address.

30. A system comprising:
a first plurality of routers that do not implement a desired protocol; and
a second plurality of routers that implement at least the desired protocol and a tunneling protocol, at least a portion of the second plurality of routers in communication with at least a portion of the first plurality of routers,
wherein a first router of the second plurality of routers comprises a first routing table entry comprising a group address, a source address and at least one outbound interface number, and wherein a second router of the second plurality of routers comprises a second routing table entry comprising the group address, the source address and at least one destination address.

31. The system of claim 30, further comprising:
a third router of the second plurality of routers comprising a third routing table entry comprising the group address, the source address and at least one additional outbound interface number, and at least one additional destination address.
